(19) United States
(12) Patent Application Publication
(10) Pub. No.: US 2010/0153291 A1
(43) Pub. Date: Jun. 17, 2010

(54) MAIL KIOSK HAVING ADDRESS VERIFICATION FUNCTIONALITY

(75) Inventors: Luis A. Jimenez, Wilton, CT (US); Angelo N. Chaclas, Southbury, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 12/332,591

(22) Filed: Dec. 11, 2008

(51) Int. Cl. G06Q 50/00; G06F 17/30

(52) U.S. Cl. 705/330; 707/E17.032

(57) ABSTRACT

A mail kiosk is provided that includes an address verification feature. The mailer is requested to input information that is known to the mailer concerning the location of the mailing address. The kiosk can then display one or more maps that allow the mailer to navigate to the desired location and select a specific location on the map where the mailer desires to send a mail piece. The kiosk can then display an aerial image of the location selected by the mailer, such that mailer can visually see the what the building at that location looks like. The mailer can then determine if the building at that location is the desired location to which the mail piece is to be sent based on the image. Upon confirmation by the mailer, the kiosk can provide the mailer with correct mailing address for the location selected by the mailer.

### FIELD OF THE INVENTION

The invention disclosed herein relates generally to kiosks utilized for processing mail, and more particularly to a kiosk that provides a user with address verification functionality.

### BACKGROUND OF THE INVENTION

Mail kiosks are known devices whereby a user is able to prepare a mail piece for mailing in a convenient fashion. Such kiosks are designed to allow the user to select a class of service desired to deliver the mail piece, weigh the mail piece, calculate the fees for delivering the mail piece using the class of service desired by the user, and print a label including an indicium that evidences payment of the delivery fee for affixing to the mail piece. Examples of such mail kiosks can be found in U.S. Pat. Nos. 5,586,037 and 6,477,514. Some mail kiosks can also print an address label based on information input by the user.

Mail kiosks are generally located in retail establishments, lobby areas of office buildings, and the like, to allow a mailer to conveniently mail a mail piece. In some situations, a mailer may be familiar with how to get to a specific location to which a mail piece is desired to be sent and know what the building at the specific location looks like, but may not know or remember the actual mailing address of the location. For example, a mailer may desire to send a post card to a friend while on vacation using a kiosk located in the hotel lobby. The mailer may know how to get to the friend's house, and knows what the friend's house looks like, but does not know, cannot remember, or is unsure of the complete actual mailing address of the friend's house. In these situations, the mailer will have to either wait to send the postcard until the mailing address is determined, or simply make a guess as to the correct mailing address and hope that the post card arrives at the friend's house. Either way, the convenience of using the mail kiosk is significantly lessened. In such situations, it would be beneficial if the mailer could accurately determine the mailing address, thereby enabling the mailer to mail the post card when desired with confidence that it will be delivered to the proper mailing address.

### SUMMARY OF THE INVENTION

The present invention alleviates the problems associated with the prior art by providing a kiosk that allows a user to obtain an address provided the user is familiar with the location of the address.

In accordance with the present invention, a mail kiosk is provided that includes an address verification feature that utilizes a mailer's familiarity with the physical location to which a mail piece is desired to be sent to obtain the actual mailing address. When the address verification feature is selected by a mailer, the user is requested to input information that is known to the mailer concerning the location of the mailing address, e.g., state, city, town, etc. The kiosk can then display one or more maps that allow the mailer to navigate to the desired location and select a specific location on the map where the mailer desires to send the mail piece. The kiosk can then display an image, such as for example, a satellite image, of the location selected by the mailer, such that mailer can visually see what the building at that location looks like. The mailer can then determine if the building at that location is the desired location to which the mail piece is to be sent based on the image. Upon confirmation by the mailer, the kiosk can provide the mailer with the correct mailing address for the location selected by the mailer.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 illustrates in block diagram form a mail kiosk according to an embodiment of present invention;

FIG. 2 illustrates in flow diagram form the processing performed by the kiosk according to an embodiment of the present invention; and

FIG. 3 illustrates in flow diagram form the processing performed by the kiosk according to another embodiment of the present invention.

### DETAILED DESCRIPTION OF THE PRESENT INVENTION

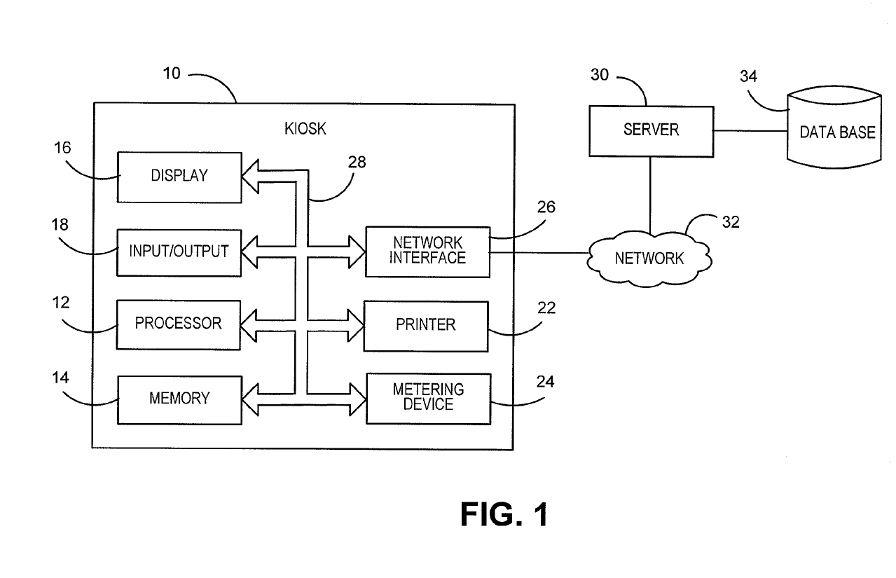

In describing the present invention, reference is made to the drawings, wherein there is seen in FIG. 1 a mail kiosk 10 according to an embodiment of the present invention. Kiosk 10 can be provided in any area, e.g., retail stores, hotel or office building lobbies, office building mail rooms, or the like, such that anyone having access to those areas can utilize the kiosk to pay for and generate indicia for delivering mail pieces. Kiosk 10 includes a processor 12 that controls operation of the kiosk 10. The processor 12 may be any type of general or special purpose processor or the like that executes one or more software routines stored in a memory 14. A display device 16, such as an LCD screen or the like, can be utilized to provide information to a user. Display 16 could also be utilized as an input device if provided with an integral touch screen. Additional input/output devices 18 may also be provided, and can include, for example, a keyboard, speaker, mouse or the like. A printer 22 is provided to print information on mail pieces or labels. Such information could include postage indicia, address labels or the like. A metering device 24 can be provided to account and generate for postage indicia. A network interface 26, e.g., modem, network card, or the like, can be provided to enable the kiosk 10 to communicate with a remote server 30 via a network 32. Network 32 can be, for example, a local area network (LAN), mobile telephone network, or the Internet. Remote server 30 can be any type of processing device, and is coupled to a database 34 used for storing information as described below. A communication bus 28 is provided to allow each of the components of the kiosk 10 to communicate with each other.

Situations may arise in which a user of the kiosk 10, referred to as the mailer, desires to use the kiosk 10 to prepare a mail piece for delivery, but may not be sure of the correct mailing address to which the mail piece is to be delivered. As used herein, a mail piece can include a postcard, letter, package or the like. In some situations, the mailer may be required to input the mailing address for a mail piece that the mailer desires to send, such as, for example, if the mailing address is required for the metering device 24 to determine the correct fee required for delivery of the mail piece or to determine if special services, e.g., insurance, confirmation delivery, etc. are available in conjunction with delivery of the mail piece. Other times, the mailer may desire to print an address label, using the printer 22, to affix on the mail piece. If the mailer is not sure of the correct mailing address, the chance that the mail piece will not be delivered successfully to the desired recipient greatly increases. The kiosk 10 provides an address verification function that allows a mailer that is familiar with the location of the mailing address, but does not know the actual mailing address, to determine the correct mailing address, thereby significantly reducing the chance that a mail piece will not be delivered successfully to the desired recipient.

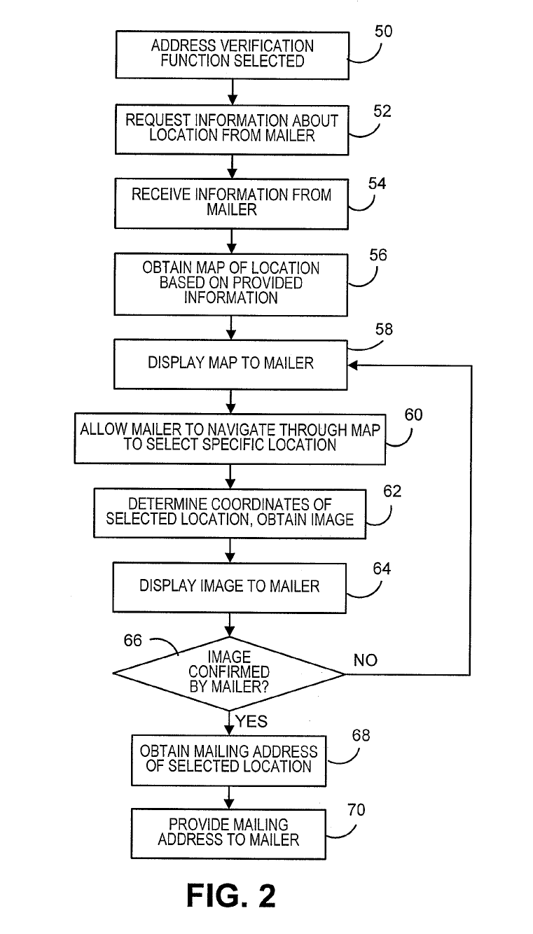

Referring now to FIG. 2, there is illustrated in flow diagram form the address verification processing that is performed by the kiosk 10 according to an embodiment of the present invention. Operation of the kiosk 10 is performed by the processor 12 executing one or more software routines stored in the memory 14 to interact with the mailer. The display 16 and/or input/output device 18 are utilized to provide and receive instructions from the mailer as to the operations desired to be performed, such as for example, as described in U.S. Pat. No. 6,477,514, which is hereby incorporated by reference. During the operation of the kiosk 10, the mailer can request an address verification function if the mailer is unsure of the mailing address to which a mail piece is desired to be sent, but is familiar with the location to which the mail piece is desired to be sent. Referring now to FIG. 2, in step 50, the address verification function is selected by the mailer, using for example, the touch screen display 16 or input device 18. Upon selection of the function, a software routine, stored in the memory 14, is called to be executed by the processor 12. In step 52, the processor 12, using the display 16, requests the mailer to input information known to the mailer about the location. Such request can be made in a series of questions to which the mailer can respond, such as, for example, requesting the mailer to input the state of the location, town or city of the location, street name of the location, and number of the location. If the mailer does not know the answer to any question, the mailer can select an “Unknown” response. In step 54, the processor 12 receives information input by the mailer in response to the request in step 52. As noted above, the mailer need only input as much information as is known to the mailer about the location, and thus need not provide a complete mailing address. However, the mailer could enter a complete address which is believed to be the correct mailing address.

In step 56, the processor 12, utilizing the information provided by the mailer in step 54, obtains a map of the location indicated by the information provided by the mailer. Such a map can be obtained, for example, using the network interface 26 to communicate with the server 30 via the network 32. The map data can be stored in the database 34 and retrieved by the server 30 to send to the kiosk 10. Alternatively, map data can be stored locally in the memory 14 of the kiosk 10. The detail of the map data is based on the information provided by the mailer. Thus, if the mailer was only able to provide the name of a state, a map of the state will be provided. If the mailer was able to provide the name of a state and city or town, the map data will be scaled down to include only the city or town of the state provided by the mailer. If the mailer entered a complete address, then the map data will be scaled further down to include the address input by the mailer and a small surrounding area, e.g., a couple of square miles. In step 58, the map data obtained by the processor 12 is displayed to the mailer using the display 16.

In step 60, the mailer is allowed to navigate through the displayed map to select a specific location. Thus, for example, if the mailer is familiar with where on a map the desired recipient is located, the mailer can simply navigate through the map, using the touch screen display 16 or input device 18, until the location desired is found. Such navigation can include, for example, changing the scale of the map to zoom in or zoom out as the mailer navigates, e.g., from a state to a town, from the town to a specific area of the town including a street, etc. The mailer can follow directions using the map to the location known to the mailer. Once the mailer has determined a desired location and selected it, then in step 62 the processor 12, using the selected location of the map, determines the geographic coordinates of the selected location, e.g., latitude and longitude. Such a determination can be done utilizing location data, e.g., map coordinates, from the location selected on the map in conjunction with a relational database stored in the database 34 or memory 14 to obtain the geographic coordinates. In addition, in step 62 the processor 12, using the obtained geographic coordinates, obtains an image of the location based on the geographic coordinates. Such image can be provided, for example, from the database 34 of server 30, or locally from the memory 14 of the kiosk 14. The image can be, for example a satellite image or any other type of aerial image, or street level image that shows the structure, e.g., building or house, located at the location selected by the mailer. In step 64, the obtained image is displayed to the mailer, using the display 16, along with a request for the mailer to confirm that the structure displayed in the image corresponds to the location to which the mailer desires to send the mail piece. The image allows the mailer to visually confirm that the selected location is in fact the location to which a mail piece is desired to be sent.

In step 66, the processor 12 determines if the mailer has provided confirmation of the image, i.e., that the structure displayed in the image is the location to which the mailer desires to send the mail piece. This confirmation can be input by the mailer using the touch screen display 16 or input device 18. If the mailer does not provide confirmation (no result in step 66), meaning that the structure is not the location to which the mailer desires to send the mail piece, then the processing returns to step 58 and a map is again displayed to the mailer such that the mailer can again navigate through the map to select a different location. For example, the mailer may have selected the proper street, but missed the house by one or two houses. Thus, using the image to obtain visual confirmation, the mailer can avoid the situation of having a correct street name but incorrect house number. When returning to step 58, the processor 12 can display an appropriate map based on the previously selected location. For example, the displayed map need not include the entire town, but instead can focus around the area of the location previously selected by the mailer. In this manner, the amount of navigation that may be required by the mailer is reduced to a minimum.

If in step 66 it is determined that the image has been confirmed by the mailer (yes result), indicating that the structure is the location to which the mailer desires to send the mail piece, then in step 68 the correct mailing address of the location selected by the mailer is obtained, using, for example, a geocoding relational database stored in database 34 or memory 14. In step 70, the obtained mailing address is provided to the mailer. This can be performed, for example, using the display 16, or by printing an address label using the printer 22 of the kiosk 10.

While obtaining and displaying of the image, and receiving confirmation provided by the mailer in steps 62-66 described above are preferable to ensure an accurate mailing address is provided, it should be understood that these are optional and need not be performed. In such a situation, once the mailer has navigated through the map and selected a specific location on the map in step 60, the processor 12 can simply obtain the mailing address of the selected location in step 68 and provide it to the mailer in step 70 without using an image.

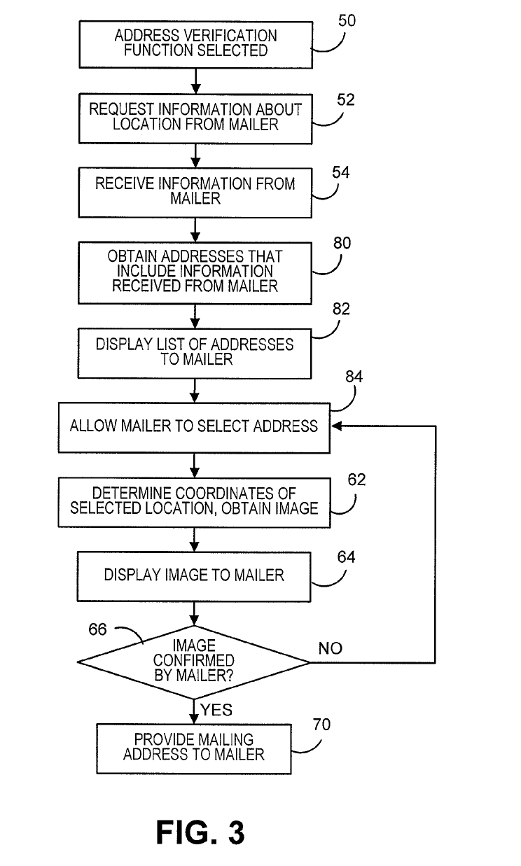

Referring now to FIG. 3, there is illustrated in flow diagram form the address verification processing that is performed by the kiosk 10 according to another embodiment of the present invention. The processing performed in FIG. 3 is similar to that of FIG. 2, except the obtaining of a map, displaying of the map, and allowing the mailer to navigate through the map as described in steps 56-60 need not be performed. In FIG. 3, the description of steps 50, 52 and 54, 62, 64, 66 and 70 are similar as described above with respect to FIG. 2 and need not be repeated here. In FIG. 3, after step 54, the processor 12 will perform an address look-up feature, in step 80, to obtain complete addresses that include the information input by the mailer in step 54. For example, if the mailer inputs a recipient name, city and state in step 54, the processor 12 will perform an address search based on the information provided and obtain the complete address for all addresses that include the input recipient name, city and state. For example, if the mailer desires to send a mail piece to Mr. Smith in New York, N.Y., the processor 12 can perform an address look-up, using a local database stored in the memory 14 or a remote database via the network 32, to obtain all addresses that include the information input by the mailer, e.g., complete address for all people named Smith that live in New York, N.Y. If the mailer inputs a completer address, then only a single address may be obtained. In step 82, the list of all addresses obtained (which may be one or more) can be displayed to the mailer. In step 84, the mailer is allowed to select an address from the list of addresses. Then in step 62 the processor 12, using the address of the selected location, determines the geographic coordinates of the selected location, e.g., latitude and longitude, and obtains an image of the location based on the geographic coordinates as described above with respect to FIG. 2. In step 64, the obtained image is displayed to the mailer, using the display 16, along with a request for the mailer to confirm that the structure displayed in the image corresponds to the location to which the mailer desires to send the mail piece. The image allows the mailer to visually confirm that the selected location is in fact the location to which a mail piece is desired to be sent.

In step 66, the processor 12 determines if the mailer has provided confirmation of the image, i.e., that the structure displayed in the image is the location to which the mailer desires to send the mail piece as described above with respect to FIG. 2. If the mailer does not provide confirmation (no result in step 66), meaning that the structure is not the location to which the mailer desires to send the mail piece, then the processing returns to step 84 to allow the mailer to select another displayed address. This process can continue until the image is confirmed by the mailer (yes result in step 66), in which case the mailing address of the image confirmed by the mailer will be provided to the mailer in step 70. This can be performed, for example, using the display 16, or by printing an address label using the printer 22 of the kiosk 10.

Thus, the mail kiosk 10 includes an address verification feature that utilizes a mailer's familiarity with the physical location to which the mailer desires to send a mail piece to obtain the actual mailing address. While the above description has been provided with respect to a kiosk, it should be understood that the invention is not so limited and could be utilized in any type of processing device, e.g., mailing machine, cell phone, PDA, and the like. While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A mail kiosk comprising:
a processing device to control operation of the mail kiosk;
an input/output device coupled to the processor;
the processing device being programmed to provide a mailing address of a location to which a mailer desires to send a mail piece by:
requesting, using the input/output device, information about the location;
obtaining a map based on the information about the location input by the mailer and displaying the map, using the input/output device, to the mailer;
allowing the mailer to navigate through the map to select a specific location that corresponds to the location to which the mailer desires to send the mail piece;
obtaining an image of the specific location selected by the mailer and displaying the image, using the input/output device, to the mailer;
requesting confirmation from the mailer that the displayed image corresponds to the location to which the mailer desires to send the mail piece;
obtaining the mailing address of the location that corresponds to the displayed image upon confirmation by the mailer; and
providing the mailing address of the location to the mailer.

2. The mail kiosk of claim 1, further comprising:
a printing device coupled to the processing device,
wherein the processor is further programmed to cause the printing device to print a label including the obtained mailing address.

3. The mail kiosk of claim 1, further comprising:
an interface device for coupling the mail kiosk to a network;
wherein the processing device obtains the map and image from a remote database via the network.

4. The mail kiosk of claim 1, wherein the input/output device includes a display with a touch screen.

5. The mail kiosk of claim 1, wherein the image is an aerial image.

6. A mail kiosk comprising:
a processing device to control operation of the mail kiosk;
an input/output device coupled to the processor;
the processing device being programmed to provide a mailing address of a location to which a mailer desires to send a mail piece by:
requesting, using the input/output device, information about the location;
displaying a list of mailing addresses that include information about the location input by the mailer;
allowing the mailer to select an address from the list of displayed mailing addresses;
obtaining an image of the address selected by the mailer and displaying the image, using the input/output device, to the mailer;
requesting confirmation from the mailer that the displayed image corresponds to the location to which the mailer desires to send the mail piece; and
providing the mailing address of the location to the mailer upon receiving confirmation by the mailer.

7. A method for determining a mailing address for a location to which a mailer desires to send a mail piece using a processing device, the method comprising:
requesting, using a display device of the processing device, information about the location from the mailer;
receiving from an input device of the processing device the information about the location from the mailer;
obtaining a map based on the information about the location input by the mailer and displaying the map, using the display device, to the mailer;
allowing the mailer to navigate through the map to select a specific location that corresponds to the location to which the mailer desires to send the mail piece;
obtaining an image of the specific location selected by the mailer and displaying the image, using the display device, to the mailer;
requesting confirmation from the mailer that the displayed image corresponds to the location to which the mailer desires to send the mail piece;
obtaining the mailing address of the location that corresponds to the displayed image upon confirmation by the mailer; and
providing the mailing address of the location to the mailer.

8. The method of claim 7, wherein the input device is a touch screen that is integral with the display device.

9. The method of claim 7, wherein obtaining a map further comprises:
obtaining the map from a remote server to which the processing device is coupled via a network.

10. The method of claim 7, wherein obtaining an image further comprises:
determining geographic coordinates of the specific location selected by the mailer; and
obtaining an image using the determined geographic coordinates.

11. The method of claim 7, wherein obtaining an image further comprises:
obtaining the image from a remote server to which the processing device is coupled via a network.

12. The method of claim 7, wherein providing the mailing address of the location to the user further comprises:
displaying on the display device the mailing address of the location.

13. The method of claim 7, wherein providing the mailing address of the location to the user further comprises:
printing a label including the mailing address of the location.

14. The method of claim 7, wherein the processing device is a mail kiosk.

15. The method of claim 7, wherein if confirmation is not received from the mailer, the method further comprises:
displaying a map, using the display device, of the selected location;
allowing the mailer to navigate through the displayed map to select a new specific location that corresponds to the location to which the mailer desires to send the mail piece;
obtaining an image of the new specific location selected by the mailer and displaying the image of the new specific location, using the display device, to the mailer;
requesting confirmation from the mailer that the displayed image corresponds to the location to which the mailer desires to send the mail piece;
obtaining the mailing address of the location that corresponds to the displayed image upon confirmation by the mailer; and
providing the mailing address of the location to the mailer.
